(19) United States
(12) Patent Application Publication
(10) Pub. No.: US 2005/0206124 A1
(43) Pub. Date: Sep. 22, 2005

(54) Gear-driven anti-tip system for powered wheelchairs

(76) Inventors: Ronald Levi, Courtdale, PA (US); James P. Mulhern, Nanticoke, PA (US); Charles J. Martis, Harding, PA (US)

Correspondence Address: DRINKER BIDDLE & REATH;ATTN: INTELLECTUAL PROPERTY GROUP, ONE LOGAN SQUARE, 18TH AND CHERRY STREETS, PHILADELPHIA, PA, 19103-6996, US

(21) Appl. No.: 11/080,696

(22) Filed: Mar. 14, 2005

Related U.S. Application Data
(60) Provisional application No. 60/553,790, filed on Mar. 16, 2004.
(60) Provisional application No. 60/553,794, filed on Mar. 16, 2004.

(51) Int. Cl. B62M 1/00

(52) U.S. Cl. 280/304.1

(57) ABSTRACT

An active anti-tip system is provided for a wheelchair having a main structural frame and a drive assembly. The anti-tip system includes at least one anti-tip wheel, a suspension arm assembly pivotally mounting the anti-tip wheel to the main structural frame, a pendulum mount for coupling the drive assembly to the main structural frame and intermeshing gears for conveying the motion of the drive assembly to the suspension arm assembly. The pendulum mount causes the drive assembly to traverse in a substantially horizontal path in response to torque input from the drive assembly. The motion of the drive train assembly is converted to pivot motion of the suspension arm by the intermeshing gears. The pivot motion of the suspension arm assembly causes the anti-tip wheel to be raised for curb/obstacle climbing and effectively lowered for pitch stability.

### CROSS-REFERENCE TO RELATED APPLICATION

This application claims the benefit of U.S. Provisional Application No. 60/553,790, filed Mar. 16, 2004 and U.S. Provisional Application No. 60/553,794, filed Mar. 16, 2004. The disclosure of these provisional applications is herein incorporated by reference.

### TECHNICAL FIELD

The present invention relates to anti-tip systems for wheelchairs, and more particularly to a new and useful anti-tip system for providing pitch stability and obstacle-climbing capability.

### BACKGROUND OF THE INVENTION

Self-propelled or powered wheelchairs have improved the mobility/transportability of the disabled and/or handicapped. Whereas in the past, disabled/handicapped individuals were nearly entirely reliant upon the assistance of others for transportation, the Americans with Disabilities Act (ADA) of June 1990 has effected sweeping changes to provide equal access and freedom of movement/mobility for disabled individuals. Notably, various structural changes have been mandated to the construction of homes, offices, entrances, sidewalks, and even parkway/river crossing, e.g., bridges, to include enlarged entrances, powered doorways, entrance ramps, curb ramps, etc., to ease mobility for disabled persons in and around society.

Along with these societal changes, the industry has created longer-running and stable powered wheelchairs. Various technologies, initially developed for other industries, are being successfully applied to powered wheelchairs to enhance the ease of control, improve stability, and/or reduce wheelchair weight and bulk. Innovations have also been made in the design of the wheelchair suspension system, e.g., active suspension systems, which vary spring stiffness to vary ride efficacy, have also been used to improve and stabilize powered wheelchairs.

One particular system which has gained popularity/acceptance is mid-wheel drive powered wheelchairs, and more particularly, such power wheelchairs with anti-tip systems. Mid-wheel drive power wheelchairs are designed to position the rotational axes of the drive wheels adjacent the center of gravity (of the combined occupant and wheelchair) to provide enhanced mobility and maneuverability. Anti-tip systems enhance stability of the wheelchair about its pitch axis and, in some of the more sophisticated designs, improve the obstacle or curb-climbing ability of the wheelchair. Such mid-wheel drive power wheelchairs having anti-tip systems are disclosed in Schaffner et al. U.S. Pat. Nos. 5,944,131 and 6,129,165, both assigned to Pride Mobility Products Corporation of Exeter, Pa.

While such designs have improved the stability of powered wheelchairs, designers thereof are continually being challenged to examine and improve wheelchair design and construction. For example, the Schaffner '131 patent discloses a mid-wheel drive wheelchair having a passive anti-tip system. The passive anti-tip system functions principally to stabilize the wheelchair about its pitch axis, i.e., to prevent forward tipping of the wheelchair. The anti-tip wheel is pivotally mounted to a vertical frame support about a pivot point which lies above the rotational axis of the anti-tip wheel. As such, the system requires that the anti-tip wheel impact a curb or other obstacle at a point below its rotational axis to cause the wheel to “kick” upwardly and climb over the obstacle.

The Schaffner '165 patent discloses a mid-wheel drive powered wheelchair having an anti-tip system which is “active” (that is, responsive to torque applied by the drive motor or pitch motion of the wheelchair frame) to vary the position of the anti-tip wheels, thereby improving the wheelchair's ability to climb curbs or overcome obstacles. More specifically, the active anti-tip system mechanically couples the suspension system of the anti-tip wheel to the drive assembly such that the anti-tip wheels displace upwardly or downwardly as a function of the magnitude of: the torque applied by the drive train assembly, the angular acceleration of the frame and/or the pitch motion of the frame relative to the drive wheels.

FIG. 1 is a schematic of one variation of the anti-tip system disclosed in the Schaffner '165 patent. The drive assembly for the drive wheel 106 and the suspension for the anti-tip system 110, are mechanically coupled by a longitudinal suspension arm 124, pivotally mounted to the main structural frame 103 about a pivot 108. A drive assembly is mounted to the suspension arm 124 at one end and an anti-tip wheel 116 is mounted to the other. In operation, torque from a drive motor 107 results in relative rotational displacement of the drive assembly 107 about the pivot 108. The relative motion therebetween, in turn, effects rotation of the suspension arm 124 about the pivot 108 in a clockwise or counterclockwise direction, depending upon the direction of the applied torque. Upon an acceleration or increased torque input (as may be required to overcome or climb an obstacle), counterclockwise rotation of the drive assembly 107 will effect an upward vertical displacement of the respective anti-tip wheel 116. Consequently, the anti-tip wheels 116 are “actively” lifted or raised to facilitate such operational modes, e.g., curb climbing. Alternatively, deceleration causes a clockwise rotation of the drive assembly 107, thus effecting a downward vertical displacement of the respective anti-tip wheel 116. The downward motion of the anti-tip wheel 116 assists to stabilize the wheelchair when traversing downwardly sloping terrain or deceleration. Again, the anti-tip system “actively” responds to a change in applied torque to vary the position of the anti-tip wheel.

Another wheelchair suspension/anti-tip system, illustrated in U.S. Patent Application Publication No. 2004/0060748, assigned to Invacare Corporation, employs an arrangement of arms that displace an anti-tip wheel in two directions. A four-bar linkage arrangement is produced to raise the anti-tip wheel when approaching or climbing an obstacle while, at the same time, causing the anti-tip wheel to automatically move rearwardly to alter the angle of incidence of the wheel.

### SUMMARY OF THE INVENTION

An active anti-tip system is provided for a powered wheelchair having a main structural frame and a drive train assembly. The anti-tip system includes at least one stabilizing or anti-tip wheel, a suspension arm pivotally mounting the anti-tip wheel to the main structural frame, a motor mount for coupling the drive assembly to the main structural frame, and intermeshing gears for conveying the motion of the drive assembly to the anti-tip wheel on the suspension arm assembly. In one embodiment, a pendulum arm is provided for the drive assembly that causes the drive assembly to traverse a substantially horizontal path in response to torque input from the drive motor. The horizontal motion of the drive assembly is converted to pivot motion of the suspension arm by the intermeshing gears. The pivot motion of the suspension arm assembly causes the anti-tip wheel to be raised for obstacle climbing or effectively lowered for providing pitch stability.

### BRIEF DESCRIPTION OF THE DRAWINGS

For the purpose of illustrating the invention, there are shown in the drawings various forms that are presently preferred; it being understood, however, that this invention is not limited to the precise arrangements and constructions particularly shown.

FIG. 1 is a schematic view of a prior art active anti-tip system for use in powered wheelchairs.

FIG. 2 is a partial side view of a powered wheelchair having one of its drive-wheels removed and portions of the chassis/body broken-away to more clearly show the relevant components of the anti-tip system according to the present invention.

FIG. 3a is an enlarged side view of the anti-tip system as shown in FIG. 2.

FIG. 3b is an enlarged top view of the anti-tip system shown in FIG. 3a.

FIG. 4 shows the anti-tip system of FIGS. 2, 3a and 3b acting in response to the motion of the drive assembly.

FIG. 5 is a partial side elevation of an alternate embodiment of the anti-tip system, wherein the anti-tip wheel is permitted to displace rearwardly by means of an extensible mount.

FIG. 6a shows an enlarged view of the extensible mount illustrated in FIG. 5.

FIG. 6b is a cross sectional view taken substantially along line 6b-6b in FIG. 6a.

FIG. 7 is a side elevation view, similar to FIG. 2, showing a further embodiment of the anti-tip system of the present invention.

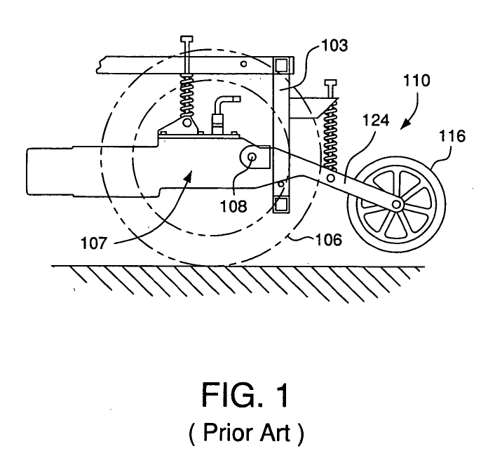

### DETAILED DESCRIPTION OF THE DRAWINGS

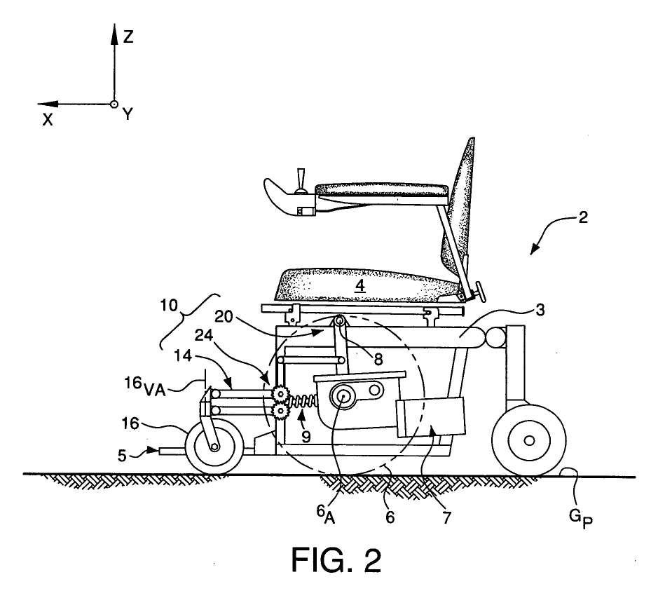

Referring now to the drawings, wherein like reference numerals identify like elements, components, subassemblies etc., FIG. 2 depicts a power wheelchair 2 having an active anti-tip system 10 according to an embodiment of the present invention. The power wheelchair 2 includes, inter alia, a main structural frame 3, a seat 4 for supporting a wheelchair occupant (not shown), a footrest assembly 5 for supporting the feet and legs (also not shown) of the occupant while operating the wheelchair 2, and a pair of drive wheels 6, one on each side of the frame 3 (only one drive wheel 6 schematically shown). Each drive wheel 6 is independently controlled and driven by a drive assembly 7. Each drive assembly 7 is pivotally mounted to the main structural frame 3 about a pivot 8 and is dedicated to driving one of the drive wheels 6 about a rotational axis 6_{A}. One or more biasing assemblies 9 are provided for biasing the drive assembly 7 to a predetermined operating position.

To facilitate the description, it will be useful to define a coordinate system as a point of reference for certain spatial relationships and/or displacements. FIG. 2 also shows a Cartesian coordinate system wherein the X-Y plane is coplanar with a ground plane Gp upon which the wheelchair 2 rests. The Y-axis is parallel to the rotational axis 6_{A} of the drive wheels 6, normal to the plane of the paper, and is referred to as the “lateral” direction. The X-axis is parallel to the direction of wheelchair forward motion and is referred to as the “longitudinal” direction. The Z-axis is orthogonal to the X-Y plane (or to the ground plane G_{P}) and is referred to as the “vertical” direction. For the purposes of describing rotational or pitch motion, rotation in a clockwise direction (as seen in this FIG. 2 and the other figures) about axes parallel or collinear with the Y-axis is “positive” and counterclockwise rotation is “negative.” As will be discussed in greater detail below, such loads and moments may, inter alia, be imposed by torque loads applied by the drive assembly 7, to accelerate the wheelchair, or loads acting on the main drive wheels 6, e.g., to brake or decelerate the wheelchair.

The active anti-tip system 10 comprises those elements of the wheelchair 2 which (i) effect stability of the wheelchair 2 about its effective pitch axis and/or (ii) enable displacement of a pitch stabilizing/anti-tip wheel to permit curb climbing or obstacle avoidance. In the context used herein, the effective pitch axis is the point about which the body of the wheelchair, i.e., the frame 3, seat 4 and wheelchair occupant, pitches either positively (upward) or negatively (downward), in response to loads and moments acting on the wheelchair 2. Such loads and moments may, inter alia, be imposed by torque applied to the drive assembly 7, e.g., to accelerate or to brake (decelerate) the wheelchair.

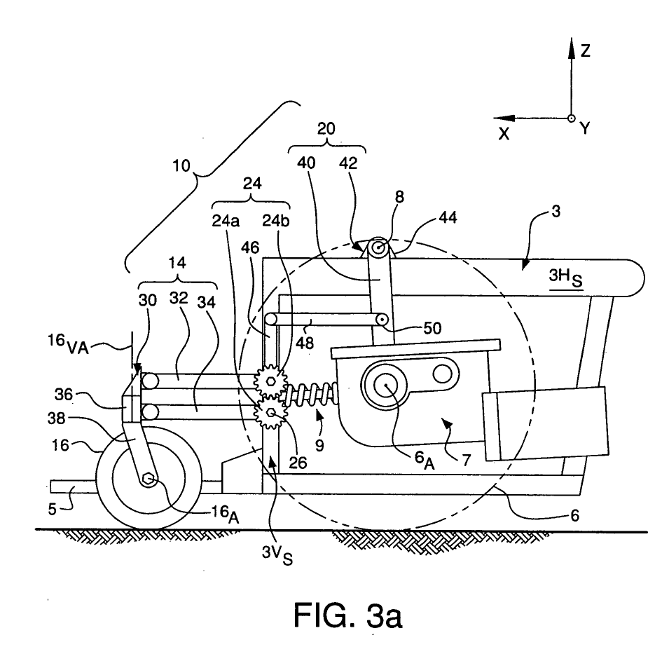

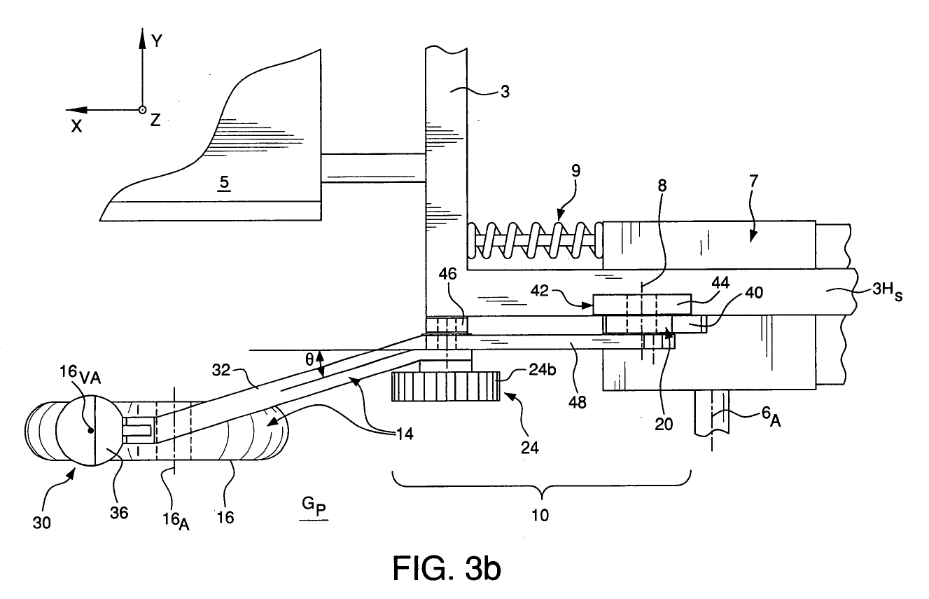

The anti-tip system 10 shown in FIG. 2 and in FIGS. 3a and 3b (collectively “FIG. 3”) includes a suspension arm assembly 14 for coupling a stabilizing or anti-tip wheel 16 to the main structural frame 3, a motor mount 20 for coupling the drive assembly 7 to the frame 3 and effecting relative motion therebetween in response to torque applied by the drive assembly 7, and intermeshing gears 24 for conveying the relative motion of the drive assembly 7 to the suspension arm assembly 14, thereby causing the anti-tip wheel 16 to be raised and lowered in response to pivot motion of the suspension arm assembly. The wheelchair 2 comprises two anti-tip systems 10, one on each side of the frame (only one shown in the drawings). Each anti-tip system 10 is connected to a drive assembly 7 on one side of the wheelchair 2.

In FIG. 3a, the suspension arm assembly 14 includes a castor assembly 30 supporting the anti-tip castor wheel 16 for rotation about a horizontal axis 16_{A}, and at least one connecting link 34 driven by and rotating with one of the intermeshing gears 24a. The castor assembly 30 is mounted at the projected end of the link 34, with a castor barrel 36 supporting the castor wheel 16 for rotation about a vertical axis 16_{VA}. As illustrated, a pair of parallel connecting links 32 and 34 are pivotally mounted at one end to the main structural frame 3 and at the other end to the castor barrel 36. The initial operating position situates the links 32, 34 in a substantially horizontal position, i.e., parallel to the ground plane G_{P}. This orientation is preferred inasmuch as the arcuate motion of the links 32, 34 from this initial position will not produce a forward component of displacement which, as will be discussed hereinafter, can jam or bind the anti-tip system 10 as the anti-tip wheel 16 impacts or bear against a curb or obstacle.

The castor assembly 30 includes a conventional yoke 38 adapted for mounting the anti-tip wheel 16 about a rotational axis 16_{A}. The castor barrel 36 may include cylindrical bearings (not shown) for enabling rotation of the wheel 16 about the vertical axis 16_{VA}. The cylindrical bearings are seated within a bore of the castor barrel 36 for accepting a vertical post (not shown) which is affixed to and extends upwardly from the yoke 38. Accordingly, the vertical post is capable of swiveling about the vertical axis 16_{VA} to facilitate yaw control/movement. The yoke 38 is shaped so that the wheel axis 16_{A} is spaced from the vertical castor axis 16_{VA}.

In FIGS. 3a and 3b, the castored anti-tip wheel 16 is in contact with the ground plane G_{P}. Space is provided between the castored anti-tip wheel 16 and the adjacent footrest assembly 5 to permit full 360 degree rotation of the anti-tip wheel 16. As shown in FIG. 3b, the footrest assembly 5 is of a width that is less than the width of the main structural frame 3, and each pair of connecting links 32, 34 extends outwardly from a respective side frame support 3H_{S} (see FIG. 3b) to increase the lateral distance between the pair of anti-tip wheels 16. Only one side frame support 3H_{S}, and consequently one anti-tip wheel 16, is shown in FIG. 3b. More specifically, in FIG. 3b each pair of connecting links 32, 34 defines an acute angle 0 with respect to the longitudinal X axis such that the anti-tip wheels are spaced a greater distance apart than their pivotal mountings of the connecting links to the structural frame 3. Alternatively, by raising the wheel 16 out of contact with the ground, a fixed axle (not shown) as compared to the castor assembly 30 may be employed such that the wheelchair may pivot freely about a yaw axis without the anti-tip wheels 16 dragging. The anti-tip wheels 16 may then be positioned closer to the footrest assembly 5.

The motor mount 20 for the drive assembly 7 includes a downwardly extending pendulum arm 40 which mounts to a pivot mount 42 on the main structural frame 3. The arm 40 pivots about the pivot axis 8. The other end of the arm 40 is fixed to the drive assembly 7. Preferably, the pivot mount 42 connects the arm 40 to the main structural frame such that the drive assembly 7 traverses a substantially horizontal path as torque causes the drive assembly 7 to rotate. In the context used herein, “substantially horizontal” means that a horizontal component of displacement is produced which is greater than the vertical component produced with each radian of angular displacement. As illustrated, the pivot mount 42 is located above the uppermost side frame support 3H_{S} and is in the form of a conventional lug fitting 44. The fitting 44 projects upwardly from the side frame support 3H_{S}. By positioning the pivot mount 42 relatively high on the frame 3, the length of the pendulum arm 40 may be increased to produce a larger horizontal component of displacement. The arm 40 is preferably aligned so that its bottom end passes directly below the pivot mount 42 within the normal range of motion of the drive assembly 7.

The intermeshing gears 24 are disposed within the kinematic path between the suspension arm assembly 14 and the motor mount 20 for conveying the motion of the drive assembly 7 to the anti-tip wheel 16. The lower gear 24a is rigidly coupled to the lower link 34 such that the gear 24a and link 34 co-rotate. The upper gear 24b is mounted on a common axis with the upper link 32. The upper gear 24b and the upper link 32 are free to rotate independently of one another. The upper gear 24b is rigidly coupled to and driven by a crank arm 46 that receives input, either directly or indirectly, from the arm 40. As illustrated, an intermediate link 48 is disposed in a substantially horizontal plane and is pivotally connected at one end to the crank arm 46 and at the other end at pivot 50 on the pendulum arm 40.

The intermeshing gears 24a, 24b are preferably spur gears mounted for rotation and juxtaposed on a vertical frame support 3V_{S} of the main structural frame 3. The crank arm 46 effects rotation of one spur gear 24b such that the other spur gear 24a rotates in an opposite direction. The length of the crank arm 46 and the distance from the main pivot 8 to the pivot 50 of the intermediate link 48 largely determines the magnitude of rotational displacement of the intermeshing gears 24 and, consequently, the magnitude and rate of displacement of the anti-tip wheel 16, as the drive assembly 7 moves.

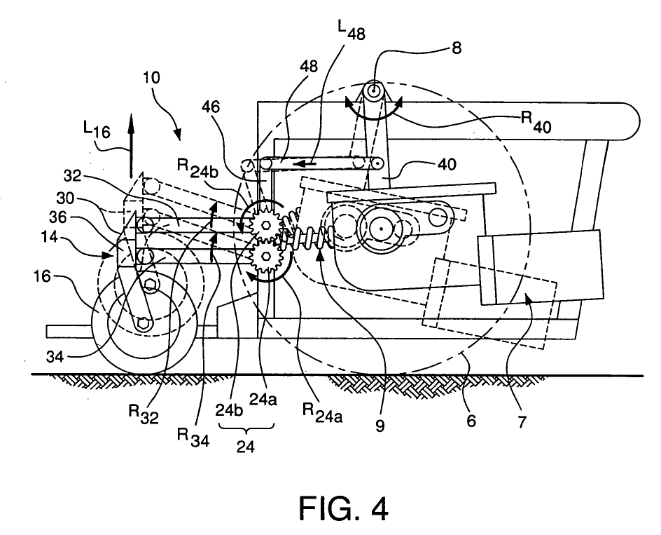

In FIG. 4, the kinematics/operation of the active anti-tip system 10 is illustrated. Solid lines in FIG. 4 show the rest position of various system elements. Dashed lines in FIG. 4 show, by way of example, displaced positions of the various system elements in a climbing operational mode wherein increased torque is created by the drive assembly 7 and applied to the drive wheels 6 as the wheelchair 2 accelerates or encounters an obstacle. In this operating mode, the pendulum mount 20 facilitates bi-directional motion R₄₀ of the drive train assembly 7 about pivot axis 8. As the pendulum mount 20 pivots forwardly, i.e., shown as clockwise rotation in FIG. 4, motion is conveyed to the intermediate link 48 in the direction of arrow L₄₈. The motion of the intermediate link 48 is conveyed to the top end of the crank arm 46 to cause the crank arm and the connected spur gear 24b to rotate in a counter-clockwise direction R_{24b}. The rotation of the spur gear 24b effects a clockwise rotation R₂₄ₐ of the intermeshing gear 24a about its axis 26. Inasmuch as the connecting link 34 is mounted to and co-rotates with gear 24b, the link 34 also rotates clockwise in the direction of arrow R₃₄ about the axis 26. The clockwise rotation of the connecting link 34 imparts upward motion L₁₆ to the castor assembly 30, raising the anti-tip wheel 16. The upward motion of the castor barrel 36 is conveyed to the second connecting or follower link 32 as a clockwise rotation R₃₂. Because the follower link 32 is not connected to, nor does it co-rotate with, the upper gear 24a, the follower link 32 does not impart rotational motion to the castor assembly 30, but controls the alignment of the castor barrel 36 and keeps the castor axis 16_{VA} substantially vertical.

In this operating mode, the anti-tip wheel 16 is caused to rise above an obstacle to allow the main drive wheels 6 to climb up and over the obstacle. When the torque levels diminish, such as when the wheelchair 2 regains normal drive input, the biasing assembly 9 causes the anti-tip system 10 to return to a normal operating position, shown as solid lines in FIG. 4. In the described embodiment, the predetermined operating position is characterized by the anti-tip wheel 16 being proximal to or in contact with the underlying ground plane G_{P}. However, it should be appreciated that the predetermined operating position may be selected such that the anti-tip wheel 16 is not in ground contact.

In a pitch stabilizing operating mode, the various elements of the anti-tip system 10, i.e., suspension arm assembly 14, intermeshing gears 24 and pendulum mount 20, rotate about the same axes, but in opposite directions. For conciseness of description, the kinematics of the anti-tip system 10 in this mode need not be fully described, but suffice it to say that the drive assembly 7 pivots in the opposite direction to effect a downward force on the anti-tip wheel 16. That is, as the powered wheelchair 2 decelerates or brakes, the anti-tip wheel 16 resists a forward pitching moment of the wheelchair 2, generated by wheelchair inertia.

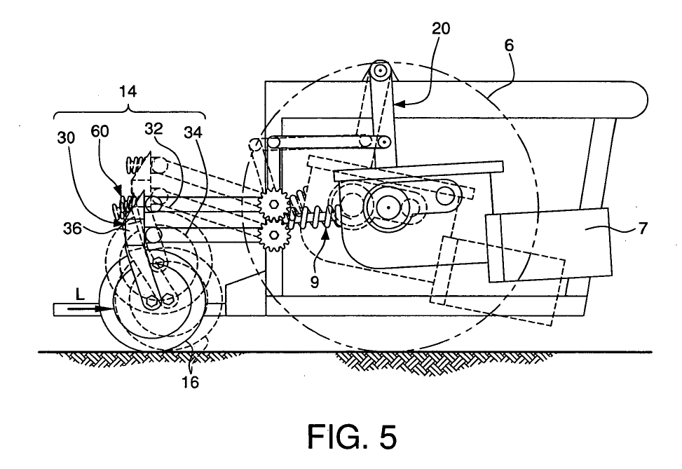

In FIG. 5, an alternate embodiment of the invention is shown wherein the suspension arm assembly 14 is adapted to facilitate inward or aft displacement of the anti-tip wheel 16. In addition to the upward displacement of the anti-tip wheel 16, the suspension arm assembly 14 enables aft displacement (shown in dashed lines) in response to an externally applied contact load L. As will be discussed in greater detail below, such aft displacement enhances the angle with which the anti-tip wheel 16 addresses a curb or obstacle (not shown). In this embodiment, the suspension arm assembly 30 facilitates angular displacement of the castor barrel 36 by extension or retraction of one of the connecting links 32, 34. More specifically, an extensible cartridge or mount 60 is employed at the juncture of the castor barrel 36 and the connecting link 32.

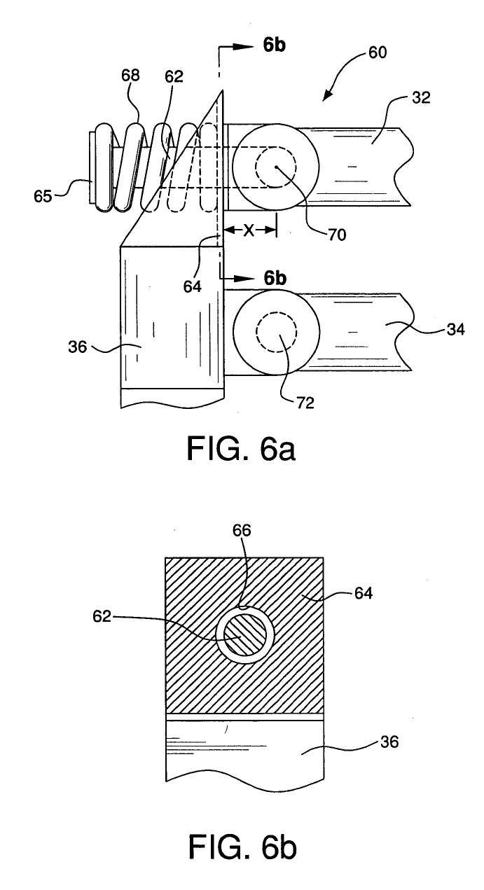

In FIGS. 6a and 6b (collectively FIG. 6), the extensible mount 60 employs an extension rod 62, a reaction fitting or plate 64 mounted to the castor barrel 36, and a spring element 68 connected at one end 65 to the rod 62 and bearing against the reaction plate 64 at its other end. The extension rod 62 is pivotally mounted to the connecting link 32 about a pivot axis 70 and passes through an aperture 66 in the reaction plate 64. The spring element 68, which connects to an end of the rod 62, allows the distance X from the pivot axis 70 to the reaction plate 64, to increase as the spring element 66 compresses due to movement of the reaction plate 64.

Operationally, as an external load L (as shown in FIG. 5) is applied to the anti-tip wheel 16, the extensible mount 60 effectively enables elongation of the connecting link 32 by increasing the distance X between the reaction plate 64 and the pivot axis 70, to facilitate angular displacement of the castor barrel 36. The castor barrel 36 pivots counter-clockwise (as seen in FIG. 5) about the pivot axis 72 where the castor barrel is mounted to the lower connecting link 34, to effect aft displacement of the anti-tip wheel 16.

Referring again to FIG. 5, the inward displacement changes the angle at which the curb impacts or addresses the anti-tip wheel 16. A more favorable impact angle can produce a vertical force component capable of pitching the front end of the wheelchair 2 upwardly, over a curb or obstacle. Further, the resiliency produced by the extensible mount 60 allows the anti-tip system 10 to overcome static friction and prevent system stall or lock-up. Situations can arise which can require the anti-tip system 10 to lift the anti-tip wheel 16 when it is at rest (not moving) and pressed forwardly against a curb or obstacle. As such, static friction within the system can prevent sufficient motor torque from developing, i.e., sufficient to raise the anti-tip wheel 16. The incorporation of a resilient mount 60 can reduce the initial force requirements of the anti-tip system 10 to overcome static friction.

Additionally, rearward displacement of the anti-tip wheel 16 by rotation about the pivot axis 72 is independent of its vertical displacement by rotation of the connecting links 32, 34. Accordingly, full aft displacement of the anti-tip wheel 16 in response to an external load can be achieved without any pivot motion created by the connecting links 32, 34. Therefore, the anti-tip wheel 16 can achieve a more favorable impact angle without requiring large torque inputs.

In summary, the anti-tip system 10 provides an advantageous system geometry for enhancing the curb climbing capability while reducing complexity, weight and cost. A simple and reliable system of intermeshing gears 24 is employed to convey motion eliminating the requirement for multiple links and bearings. Furthermore, the anti-tip system 10 employs a resilient suspension arm assembly 14 for lifting/raising the anti-tip wheel in a vertical direction while also enabling inward/aft displacement. As discussed in the preceding paragraphs, such resilient suspension arm assembly 14 enhances the angle with which an anti-tip wheel addresses a curb or obstacle while preventing system stall or lock-up.

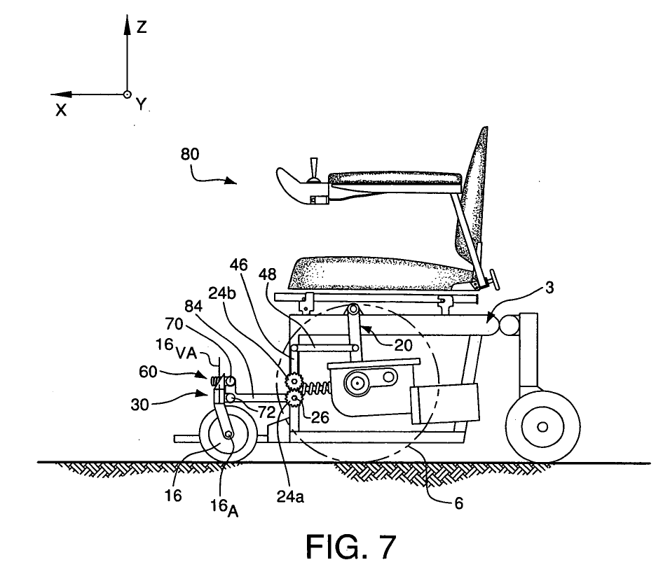

Referring now to FIG. 7, a further form of power wheelchair is shown that is essentially the same as the modified power wheelchair 2 shown in FIGS. 5 and 6, except that the anti-tip mechanism has a single connecting link 84. The connecting link 84, like the connecting link 34 previously described, is rigidly connected to the spur gear 24a. The connecting link 84 carries both of the pivots 70 and 72, and there is no upper connecting link 32.

As in the wheelchair 2, when the pendulum mount 20 pivots forwardly, clockwise as shown in FIG. 7, forward motion is conveyed to the intermediate link 48. The motion of the intermediate link 48 is conveyed to the top end of the crank arm 46 to cause the connected spur gear 24b to rotate counter-clockwise. The rotation of the spur gear 24b effects a clockwise rotation of the intermeshing gear 24a. The connecting link 84 co-rotates with intermeshing gear 24a, and also rotates clockwise. The clockwise rotation of the connecting link 84 imparts upward motion to the castor assembly 30, raising the anti-tip wheel 16. Because there is no follower link 32, and both of the pivots 70 and 72 are directly connected to the connecting link 84, the connecting link imparts its rotational motion to the castor assembly 30. Consequently, the castor barrel 36 and the castor axis 16_{VA} do not remain vertical. Instead, the upper end of the castor axis 16_{VA} tilts aft as the anti-tip wheel 16 rises.

The wheelchair 80 also has an extensible mount 60, which functions in substantially the same way as that shown in FIGS. 5 and 6. The upper pivot 70 in the wheelchair 80 serves to join the extension rod 62 (see FIG. 6a) of the extensible mount 60 to the connecting link 84. This pivot 70 may be replaced by a rigid attachment of the extension rod to the connecting portion of link 84.

While the anti-tip system 10 has been described in terms of an embodiment which exemplifies an anticipated use and application thereof, other embodiments are contemplated which also fall within the scope and spirit of the invention. While the anti-tip system 10 has been illustrated and described in terms of a forward anti-tip system, the anti-tip system is equally applicable to an aft anti-tip system which stabilizes an aft tipping motion of a wheelchair. Furthermore, the specific embodiment shows the anti-tip wheel 16 as being in contact with the ground plane, however, as discussed above, the anti-tip wheel 16 may be in or out of ground contact depending in part upon whether a fixed or castored wheel is employed.

Moreover, while the adaptable anti-tip system 10 employs an extensible upper connecting mount 60, it will readily be appreciated that either connecting link may be extensible or retractable. For example, the anti-tip system 10 may employ a retractable, i.e., telescoping, lower link (not shown) to enable rotation of castor assembly 30 as a curb impacts the anti-tip wheel. Furthermore, the extensible mount 60 as shown includes an external coil spring 68 for biasing the tension rod 62. The spring may be disposed externally or internally depending upon the configuration of the tension rod 62 and replaced with other resilient elements.

As explained above, in the wheelchairs 10 shown in FIGS. 2 to 6, the connecting links 32, 34 are substantially horizontal in the resting position (shown in solid lines in FIGS. 4 and 5). With this configuration, the anti-tip wheel 16 moves substantially vertically for small movements of the suspension arm assembly 14. The anti-tip wheel 16 moves aft for larger movements of the suspension arm assembly 14, whether up or down. However, by positioning the axis 26 at the aft end of the connecting link 34 higher or lower than the pivot axis 72 at the forward end of the connecting link the anti-tip wheel 16 can be given a motion that is initially forward or aft, respectively, as the anti-tip wheel rises. The greater the difference in initial height between the two pivots, the more pronounced the initial forward or aft movement will be. In the wheelchair 80 shown in FIG. 7, it will be seen that the relative height of the wheel axis 16A and the axis 26 is the determining dimension.

As explained above, if the extensible mount 60 is present, contact between the wheel 16 and an external object tends to cause the wheel 16 to pivot aft about the axis 72. The pivoting motion will tend to have an upward component, depending on the X component of the separation between the axes 16A and 72. If the external object contacts the anti-tip wheel well below the center of the wheel, the anti-tip wheel may tend to ride over the object. The contact height below which the anti-tip wheel 16 rides over the object depends primarily on the pre-tension in the spring 62 and on the resistance to lifting of the suspension arm assembly 14.

A force component tending to lift the suspension arm assembly 14 is generated if the point of contact with the external object is below a line joining the axis 26 and the wheel axis 16A. In practice, the level below which the contact will lift the suspension arm assembly 14 (assuming that the contact force is not taken up by the extensible mount 60 if provided) is influenced by constructional practicalities, including the preload in the suspension assembly 9, friction and other resistance to movement of the mechanism, and the magnitudes of other forces involved. However, the position of the axis 26 of the connecting link 34 at the spur gear 24a is usually a significant factor.

As mentioned above, the relative angles of rotation of the drive assembly 7 and the anti-tip assembly, are determined primarily by the ratio of the distance between the pivots 8 and 50 to the length of the crank arm 46. Thus, if the pivot 26 is moved up or down to adjust the geometry and kinematics as discussed above, the intermediate link 48 may be repositioned to maintain a desired rate of lift of the anti-tip wheel 16.

Further, a variety of other modifications to the embodiments will be apparent to those skilled in the art from the disclosure provided herein. Thus, the present invention may be embodied in other specific forms without departing from the spirit or essential attributes thereof and, accordingly, reference should be made to the appended claims, rather than to the foregoing specification, as indicating the scope of the invention.

1. An active anti-tip system for a powered wheelchair, the wheelchair having a main structural frame and a drive assembly, the drive assembly driving a main drive wheel about a rotational axis, the anti-tip system comprising:
at least one anti-tip wheel;
a suspension arm assembly pivotally mounting said anti-tip wheel to the main structural frame;
a mount for pivotably coupling the drive assembly to the main structural frame and effecting relative motion therebetween in response to the torque created by the drive assembly; and,
intermeshing gears for conveying said relative motion of the drive assembly to said suspension arm assembly thereby causing the anti-tip wheel to be raised in response.

2. The active anti-tip system according to claim 1 wherein said drive assembly mount includes a substantially downwardly extending pendulum arm affixed to said drive assembly at one end thereof and a pivot coupling the other end to the main structural frame, said mount defining a pivot axis disposed vertically above drive wheel axis.

3. The active anti-tip system according to claim 1 wherein said intermeshing gears include a pair of gears each having an axis parallel to the rotational axis of the drive wheels, one of said gears driven by an arm connecting to the drive assembly, and the other of said gears driving and rotating a connecting link of said suspension arm assembly, said connecting link projecting from the main structural frame of the wheelchair.

4. The active anti-tip system according to claim 1 wherein said suspension arm assembly further comprises a resilient mount for enabling inward displacement of said anti-tip wheel in response to an external impact load.

5. The active anti-tip system according to claim 1 wherein said suspension arm assembly further comprises a castor assembly mounting to and supporting the anti-tip wheel for rotation about a vertical axis, at least one connecting link driven by and rotating with one of said intermeshing gears at one end thereof and the castor assembly mounted at the other end.

6. The active anti-tip system according to claim 5 further comprising a resilient mount interposed between said castor assembly and said connecting link to effect inward displacement of said anti-tip wheel in response to an external impact load.

7. The active anti-tip system according to claim 6 wherein the resilient mount comprises an extension rod, a reaction plate mounted to said castor assembly and a spring element connecting at one end to said extension rod and bearing against said reaction plate at its other end, said extension rod pivotally mounted to said connecting link.

8. The active anti-tip system according to claim 1 wherein the drive assembly mount includes a substantially downwardly extending pendulum arm affixed to said drive assembly at one end thereof, and a pivot coupling the other end of said pendulum arm to the main structural frame, wherein said intermeshing gears include first and second spur gears, said suspension arm assembly includes at least one connecting link mounted to and driven by said first spur gear, a crank arm for driving said second spur gear, and an intermediate link pivotally mounted at opposite ends to said pendulum arm and said crank arm.

9. The active anti-tip system according to claim 1 wherein the drive assembly mount further comprises a substantially downwardly extending pendulum arm affixed to said drive train assembly at one end thereof and a pivot coupling at the other end, the pivot coupling supported on the main structural frame, wherein said intermeshing gears include first and second gears, wherein said suspension arm assembly includes at least one connecting link mounting to and driven by said first spur gear, and further comprising at least one input arm for driving said second gear.

10. A power wheelchair comprising:
a frame;
a seat mounted on the frame;
a pair of drive wheels,
a drive assembly for driving each of said drive wheels;
at least one pitch stabilizing wheel;
a suspension arm assembly pivotally mounting said stabilizing wheel to said main structural frame;
a pendulum mount for coupling each of said drive train assemblies to the main structural frame and effecting relative horizontal motion therebetween in response to torque applied to the main drive wheels by the drive assembly; and
intermeshing gears for conveying the motion of each said drive assembly to the respective suspension arm assembly, thereby causing said stabilizing wheel to be raised or lowered in response to pivot motion of said suspension arm assembly.

11. The powered wheelchair according to claim 10 wherein said pendulum mounts include a substantially downwardly extending arm affixed to said drive assembly at one end thereof, and a pivot mount coupling the other end of the pendulum arm to the main structural frame, said pivot mount defining a pivot axis disposed vertically above the axis of the drive wheels.

12. The powered wheelchair according to claim 10 wherein said intermeshing gears include a pair of gears each having an axis parallel to the rotational axis of the drive wheels, one of said gears driven by an arm connecting to the drive assembly, and the other of said gears driving and rotating with a connecting link of said suspension arm assembly, said connecting link projecting forwardly of mains structural frame of the wheelchair.

13. The powered wheelchair according to claim 10 wherein said suspension arm assembly is resilient, enabling inward displacement of said stabilizing wheel in response to an external impact load.

14. The powered wheelchair according to claim 10 wherein said suspension arm assembly includes a castor assembly mounting to and supporting the stabilizing wheel for rotation about a vertical axis, at least one connecting link driven by and rotating with one of said intermeshing gears at one end thereof and pivotally mounting to the castor assembly at the other end, and a resilient mount interposing said castor assembly and said connecting link to effect inward displacement of said wheel in response to an external impact load.

15. The powered wheelchair according to claim 14 wherein said resilient mount includes an extension rod, a reaction plate mounted to said castor assembly and defining an aperture for accepting said extension rod, and a spring element connecting at one end to said extension rod and bearing against said reaction plate at its other end, said extension rod pivotally mounted to said connecting link

16. The powered wheelchair according to claim 10 wherein said pendulum mount includes a substantially downwardly extending arm affixed to said drive assembly at one end thereof and a pivot mount coupling the other end to the main structural frame, wherein said intermeshing gears include first and second spur gears, said suspension arm assembly further comprising at least one connecting link mounting to and driven by said first spur gear, a crank arm for driving said second spur gear, and an intermediate link pivotally mounted at opposite ends to said pendulum arm and said crank arms.

17. The powered wheelchair according to claim 10 wherein said pendulum mount comprises a substantially downwardly extending arm affixed to said drive assembly at one end thereof and a pivot mount at the other end coupling the pendulum arm to the main structural frame, wherein said intermeshing gears include first and second gears, said suspension arm assembly comprising at least one connecting link mounting to and driven by said first spur gear and at least one input arm for driving said second gear.

18. The powered wheelchair according to claim 17 wherein said suspension arm assembly is resilient for enabling inward displacement of said anti-tip wheel in response to an external impact load.

19. A wheelchair, comprising:
a frame;
at least one drive wheel rotationally mounted on the frame;
an suspension arm assembly projecting frame one end of the frame, the suspension arm including a castor assembly mounted to and supporting an anti-tip wheel for rotation about a vertical axis;
a castor mount assembly to effect inward displacement of said anti-tip wheel in response to an external impact load; and
a resilient device acting between the castor mount assembly and said castor assembly to resiliently oppose said inward displacement;
wherein said resilient device comprises
a reaction plate mounted to said castor mount assembly,
an extension rod mounted at one end to said suspension arm, and
a spring element connecting at one end to said extension rod and bearing against said reaction plate at the other end.

20. The wheelchair according to claim 19, wherein said extension rod is pivotally mounted to said suspension arm assembly.

21. The wheelchair according to claim 19, wherein said suspension arm assembly comprise two connecting links, each link pivotably mounted at one end to the frame and at the opposite end to the castor mount assembly.

22. The wheelchair according to claim 19, further comprising a drive assembly for powering the drive wheel.

23. The wheelchair according to claim 22, further comprising an anti-tip system actively connecting the drive assembly with the suspension arm assembly for causing the anti-tip wheel to be raised in response to the torque input of the drive assembly to the drive wheel.

24. The wheelchair according to claim 23 wherein the anti-tip system further comprises a pair of gears and a linkage connection, the linkage connecting the drive assembly to one of the gears to rotate the gear in response to movement of the drive assembly, the second gear being rotated by the first gear and operatively coupled to the suspension arm to rotate the arm therewith to affect the raising of the anti-tip wheel.

25. The wheelchair according to claim 24 wherein the linkage connection further comprises a pendulum arm pivotably supported on the frame at one end and having the drive assembly suspended at the opposite end at a position relatively below the pivot support.
